(19) United States
(12) Patent Application Publication
(10) Pub. No.: US 2018/0084250 A1
(43) Pub. Date: Mar. 22, 2018

(54) SYSTEM AND METHOD FOR DETERMINIG AND UTILIZING PRIORITY MAPS IN VIDEO

(71) Applicant: VIDEOPURA, LLC, Delray Beach, FL (US)

(72) Inventor: Velibor Adzic, 33431, FL (US)

(73) Assignee: VIDEOPURA, LLC, Delray Beach, FL (US)

(21) Appl. No.: 15/564,553

(22) PCT Filed: Apr. 11, 2016
(86) PCT No.: PCT/US16/26875

§ 371 Date: Oct. 5, 2017

Related U.S. Application Data
(60) Provisional application No. 62/145,509, filed on Apr. 10, 2015.

(51) Int. Cl. H04N 19/115; H04N 19/40; H04N 19/154; H04N 19/179; H04N 19/46

(52) U.S. Cl. CPC H04N 19/115; H04N 19/40; H04N 19/46; H04N 19/179; H04N 19/154

(57) ABSTRACT

A system for video streaming may include a video receiver configured to receive a video sequence. The system may further include a video priority analyzer configured to calculate coefficients that correlate cognitive or perceptual priority with spatial, temporal, or audio elements of the video sequence. The video priority analyzer may further determine a priority map using the calculated coefficients. The priority map may include a set of coefficients that is associated with a video interval of the video sequence. A video decision router may be configured to select a transcoding technique or bitrate level for each video packet based on the determined priority map. Further, the video decision router may transmit the packet according to the selected transcoding technique or bitrate level.

### CROSS REFERENCE TO RELATED APPLICATIONS

This application claims priority to U.S. Provisional App. Ser. No. 62/145,509, titled “System and Method for Determining and Utilizing Priority Maps in Video”, filed Apr. 10, 2015, the disclosure of which is hereby incorporated by reference in its entirety.

### BACKGROUND

The present disclosure relates to digital media, and more specifically, to video coding and analysis.

Modern hybrid coding techniques can provide for efficient video compression. Components of those techniques, such as motion compensation, frequency transforms, uniform quantization and entropy coding can be built as generic tools that can be applied to a wide variety of input video content. While certain techniques are improving over time due to the advancement in computational resources, aspects that are beyond the scope of such approaches should be considered for further improvement.

Video is prepared and coded to be presented to human viewers, making Human Visual System (HVS) the ultimate receiver where the final processing stage takes place. Processing using the HVS can be very efficient—signals may be compressed through a cascade of biological visual filters, from the low level retina to the more complex cognitive filters in the cortex of the brain. A similar mechanism can be employed by the auditory system for audio signals. In order to optimize video coding in the digital domain for human viewership, algorithms may be developed that reduce redundant information which may be filtered out by the human brain. Certain methods may use only a small subset of HVS characteristics—i.e. low pass spatial and temporal filtering. However, there exists an opportunity to consider further characteristics of the HVS, in both perceptual and cognitive aspects.

### SUMMARY

The disclosed subject matter provides techniques implemented as a part of the video encoder and/or video delivery infrastructure that can eliminate redundant information allowing for better utilization of available bandwidth while achieving the same quality of experience for the end user. An exemplary system uses a content analysis algorithm that models subjective quality by correlating attributes of HVS to the content characteristics. Quality estimation can be based on both perceptual and cognitive characteristics. Associated quality estimation can be assigned as the priority attribute to the parts of the video sequence and can be utilized for video processing, transcoding and re-purposing.

An exemplary system for video streaming may include a video receiver configured to receive a video sequence. The system may further include a video priority analyzer configured to calculate coefficients that correlate cognitive or perceptual priority with spatial, temporal, or audio elements of the video sequence. The video priority analyzer may further determine a priority map using the calculated coefficients. The priority map may include a set of coefficients that is associated with a video interval of the video sequence. A video decision router may be configured to select a transcoding algorithm or bitrate level for each video packet based on the determined priority map. Further, the video decision router may transmit the packet according to the selected transcoding algorithm or bitrate level.

### BRIEF DESCRIPTION OF THE DRAWINGS

Further features, the nature, and various advantages of the disclosed subject matter will be more apparent from the following detailed description and the accompanying drawings in which:

FIG. 1 is a schematic diagram of a system for generating a priority map for an input video sequence in accordance with an embodiment of the disclosed subject matter;

FIG. 2 is a depiction of a video timeline divided into intervals with associated coefficient sets in accordance with an embodiment of the disclosed subject matter;

FIG. 3 is a schematic diagram of a video priority analyzer in accordance with an embodiment of the disclosed subject matter;

FIG. 4 is a depiction of a smart channel node in accordance with an embodiment of the disclosed subject matter;

FIG. 5 is a detailed depiction of a video decision router implemented in a smart channel node in accordance with an embodiment of the disclosed subject matter.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

Perceptual characteristics of the HVS can be used in modern video coding algorithms. While certain coding techniques apply low pass filters broadly, more informative analysis of video content may be additionally considered and represented through the spatio-temporal characteristics and motion. Cognitive characteristics of the HVS can also be considered. These characteristics can be different for each video sequence based on the overall context and underlying structure of a video sequence. The way user's brain is processing visual and auditory information can thus depend upon these cognitive characteristics.

Accordingly, embodiments of the disclosed subject matter can provide techniques capable of both extracting content-based information and utilizing available video metadata information, thus providing additional parameters that can be correlated with perceptual and cognitive priorities based on the HVS. These parameters can be used for improved video coding and processing. Furthermore, by providing a model of correlation between content information and quality of experience, this system can allow improvement or optimization of content delivery. For example, while certain systems may only consider bandwidth in determining the quality or bitrate level to send video, the disclosed subject matter may consider which specific elements in a video can be transmitted at a lower quality if human cognitive characteristics allow for ignoring these elements.

Embodiments of the disclosed subject matter allow refined encoding and transcoding of input video sequences based on perceptual and cognitive characteristics. For example and not by limitation, a method of video streaming may include calculating a priority map identifying a set of coefficients for each video interval of a video sequence. The set of coefficients may correlate cognitive or perceptual priority with spatial, temporal, or audio elements of each video interval. Further, prior to or at the time of transmission, a transcoding technique or bitrate level may be determined for each segment of the video sequence based on the priority map. The video interval may then be transmitted according to the determined transcoding technique or bitrate level.

The cognitive or perceptual priority that is correlated with elements of the video may be based on characteristics of a human visual system (HVS), which consider visual or temporal elements that are elevated or ignored based on human perception of the video. For example, a person viewing a video sequence may prioritize the audio dialogue of a particular scene due to its importance to a story element in the video. Accordingly, the audio dialogue may have a high priority according to the HVS, and the audio signal of the video sequence may be presented without any degradation. Further, the other elements of the video, such as the spatial and temporal layers may have less priority for a view at that time. These elements may be transmitted more efficiently and at lower quality (e.g., at a lower bitrate) without any noticeable degradation in overall quality of the transmitted video.

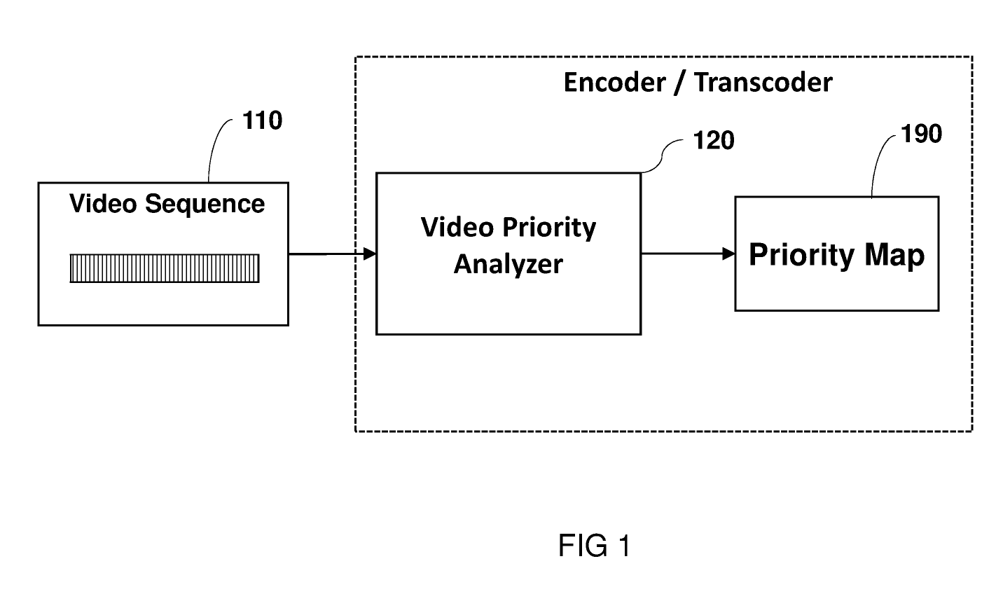

As depicted in FIG. 1, a video priority analyzer (VPA) 120 can be used to generate a PM 190. A priority map (PM) 190 may be generated that designates parts of a video in both spatial and temporal domains to associated perceptual and cognitive significance coefficients. As input to the VPA 120, a video sequence 110 that can either be a raw video sequence, or the video sequence 110 may already be an encoded video bitstream that can be transcoded. The decision process in encoding/transcoding is based on the generated PM 190, thus guaranteeing optimal result in the perceptual and cognitive aspects. VPA 120 can be implemented as a part of encoder/transcoder and allow for both real time and on demand operation.

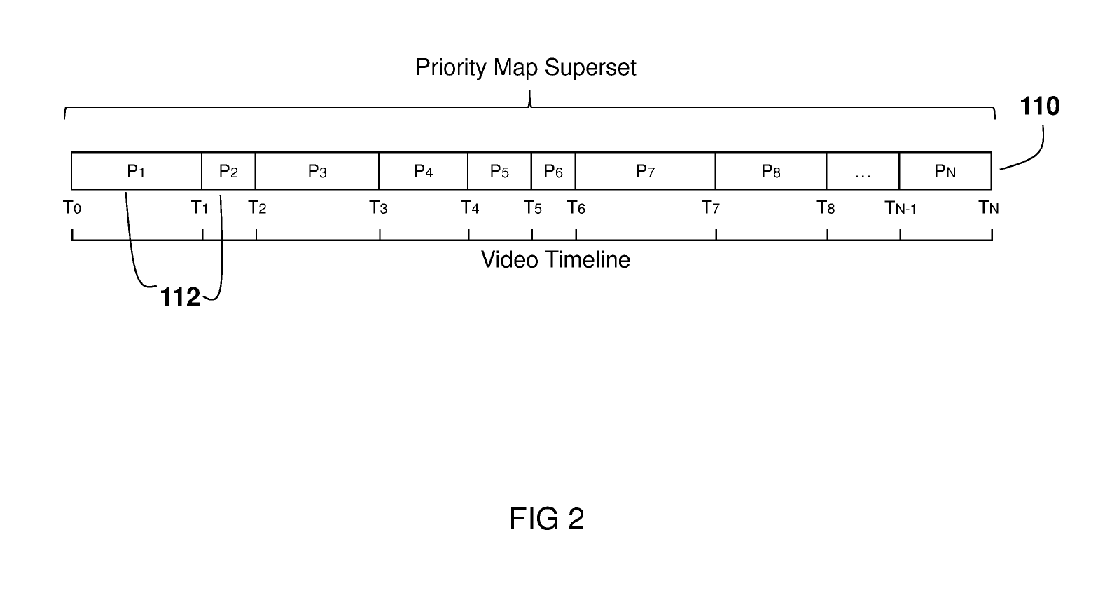

The PM 190 can be defined as a superset containing coefficient sets defined for the parts of the video sequence. As depicted in FIG. 2, a video sequence 110 may be divided into video intervals 112 of variable duration. Each interval k can be defined by its starting time Tₖ₋₁ and a duration that may be calculated as Tₖ−Tₖ₋₁. Each interval 112 can be defined as a local self-containing unit of the video sequence. For example, interval 112 can be aligned with a scene so that it begins and ends on two consecutive scene changes. Each interval k can be associated with a coefficient set Pₖ. The set Pₖ may contain coefficients that represent perceptual and cognitive parameters associated with the interval k. The coefficients may, for example, correlate perceptual and cognitive priority with spatial, temporal, or audio elements of each video interval. Interval boundaries can be calculated such that the difference between coefficient sets associate with two consecutive interval coefficient sets is maximized.

By way of example and not limitation, the differences between the set of coefficients may be calculated based on the sum of squared differences, the vector difference between sets of coefficients, or other difference measurements as known in the art. The sum of the durations of all intervals may be equal to the duration of video sequence. Each interval can be associated with its coefficient set.

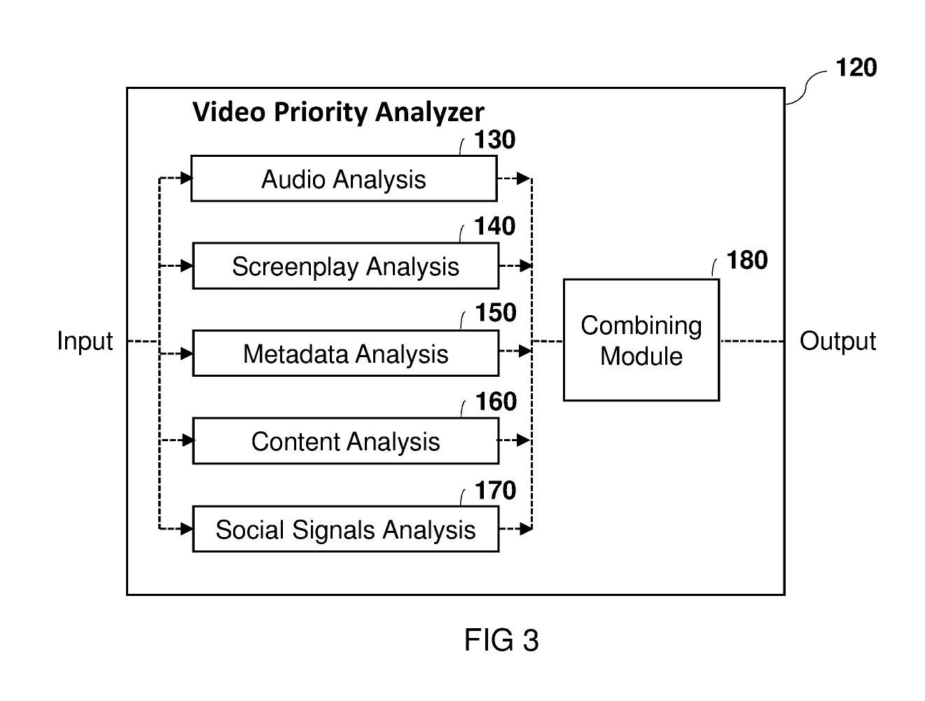

VPA 120 may contain multiple modules that are used for analysis. As depicted in FIG. 3, VPA 120 may comprise the following analysis modules: Audio Analysis (AA) 130, Screenplay Analysis (SA) 140, Metadata Analysis (MA) 150, Content Analysis (CA) 160 and Social Signals Analysis (SS) 170. Each module receives as input a video sequence or parts of it, or a video bitstream or parts of it, or some associated data such as metadata or closed captioning. The output of each module may be a coefficient that is calculated as a representation of a correlated perceptual or cognitive parameter. In the absence of required input, a module can produce a skipped coefficient. Non-skipped coefficients can be passed to the Combining Module (CM) 180 that calculates interval boundaries and compresses coefficients using entropy coding methods, such as Huffman coding and arithmetic coding. The output of the Combining Module is a PM 190 for a given input video.

The AA 130 module may calculate coefficient C_{AA} based on the audio tracks and channels that are associated with the video track in the input video sequence. C_{AA} can represent both perceptual and cognitive aspects of the HVS. Frequency and amplitude of input signal can be correlated with the pitch and loudness perceived by the auditory system. Variable duration windows may be used to filter and analyze both perceptual and cognitive priority of a given audio signal. Further, temporal masking can be used to identify parts of the audio signal that has lower priority.

The SA 140 module may calculate coefficient C_{SA} based on the hints and overall dynamic of an underlying story as represented in the screenplay of the video sequence. C_{SA} primarily represents a cognitive aspect of the HVS. Story description can be analyzed for directorial cues and hints of significant moments in the timeline of the video sequence. Text associated with the video sequence (e.g., through metadata or closed captioning) can be analyzed for frequency of occurrence of events, objects, and persons. Further, the appearance of actors in main roles can be identified and weighted as cognitively prioritized.

The MA 150 module may calculate coefficient C_{MA} based on the metadata that is either provided with the input video or is obtained from other sources. C_{MA} may represent primarily cognitive aspects of the HVS. Examples of metadata are transcripts, close captions, labels, director's comments, or any complimentary data associated with the video sequence. Since this module may evaluate a broad spectrum of input data, the module may contain sophisticated multimodal data analysis tools. The MA module 150 may be used to complement SA 140 module in analyzing high level contextual data. It may also be useful in cases where module SA 140 produces a skipped coefficient, and only module MA 150 provides contextual information.

The CA 160 module may calculate coefficient C_{CA} based on the video track and analysis of its content. C_{CA} may represent primarily perceptual aspects of the HVS. The coefficient is calculated as a 3-tuple (C_{CA}¹, C_{CA}², C_{CA}³) of three elements. The first element C_{CA}¹ can be calculated by analyzing scene characteristics of the video bitstream. The information that is extracted may relate to scene duration and scene changes. Scene duration, temporal dynamics of scene changes, and the strength of transition between subsequent scenes is used to calculate C_{CA}¹ based on temporal masking, where the perception of one sound or visual may be affected by the presence of another sound or visual. Information about temporal transitions is extracted for spatially overlapping regions of subsequent frames in the video sequence. Regions of the frames that exhibit a change in luminosity and texture between two frames may be temporally masked and thus have low priority according to the perceptual aspect of the HVS. This element can play a role in CM 180 module's task of determining interval boundaries.

The C_{CA}² element may be calculated by analyzing motion information extracted from the video bitstream. Information about motion is represented using motion vectors (MVs) that show the displacement of a frame region that may occur between subsequent frames. Using motion vectors (“MV”), the velocity of moving regions can be calculated based on MV magnitude:

V=\sqrt{MV_{X}²+MV_{Y}²}, (1)

where MV_{X} and MV_{Y} are horizontal and vertical components of MV. Furthermore, the orientation of the motion may be extracted by calculating the angle of motion:

$$A = arctan \frac{{MV}_{Y}}{{MV}_{X}} , \qquad ( 2 )$$

where MV_{Y} and MV_{X} are vertical and horizontal components of MV, and A is an angle between vector and horizontal axis. Based on the velocity and orientation information a coherency of motion can be calculated and a motion masking model can be employed that allows for more distortions in the regions of high velocity based on the fact that human eyes cannot track those regions and hence the perceived visual image is not stabilized on the retina, giving it low perceptual priority.

The C_{CA}³ element may be calculated using the spatial masking model based on the texture and luminosity information extracted from the content of the video bitstream. A contrast sensitivity function (CSF) and just-noticeable-difference (JND) as known in the art can be used to calculate distortion tolerability for all frames in the sequence based on the frequency domain information. This element can be calculated in the spatial domain of a frame in the video sequence, designating perceptual priority for specific regions of frames or for whole frames.

The SS 170 module calculates coefficient C_{SS} based on the social media and other information available on a pre-defined Internet source that is related to the input video sequence 110. C_{SS} may represent a primarily cognitive aspect of the HVS. Efficient web crawlers may be implemented to search for information on social networks such as Twitter and Facebook, together with websites like YouTube, IMDb, Rotten Tomatoes, etc. A pre-defined list of web sources that have high probability of containing relevant social information is maintained and kept updated. The web crawler can gather information from pre-defined sources and store it in the repository containing Social Signal information for video sources. This information can be analyzed and relevant parameters are used to designate cognitively high priority intervals in the input video. Some social signals can have associated timeline information. For others, an algorithm can be implemented that matches the social signals to the timeline, based on the information from previous modules. This module can provide complementary information to previous cognitive aspect modules.

The coefficients calculated by the aforementioned modules illustrated in FIG. 3 may have a value anywhere from 0 to 1 inclusive; with 0 representing the lowest priority and 1 representing highest priority. This range of values makes coefficients suitable for the efficient entropy coding that is implemented in CM 180.

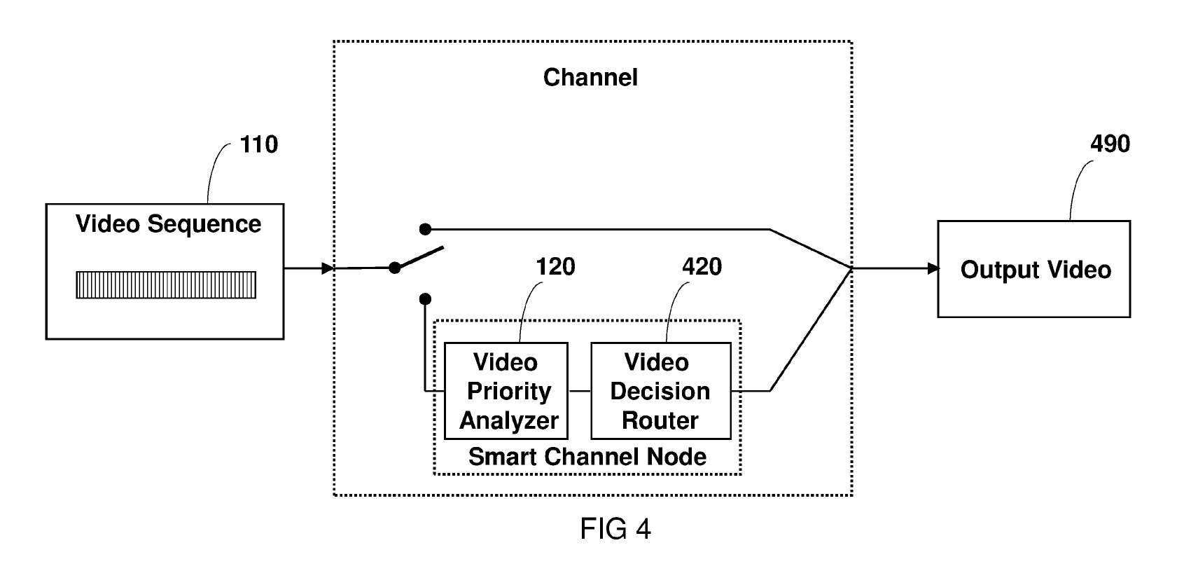

The output of CM 180 is the PM 190 (see, e.g., FIGS. 1 and 2) that is associated with the input video sequence. FIG. 4 is a depiction of a smart channel node in accordance with an embodiment of the disclosed subject matter. As a tool that enables improved or optimized video coding, VPA 120 can be implemented as a part of video encoder or deployed as part of a smart channel node (SCN) that enables optimized network utilization. As shown in FIG. 4, if the Video Source 410 does not have associated PM 190 it can be transmitted as is, or it can be delivered through the SCN that contains the VPA 120 and a video decision router (VDR) 420. The implementation of the SCN may allow for bitrate savings through transcoding or packet/segment decision process that is based on PM 190. In this way, parts of a video sequence that have high priority can be transmitted without degradation, while other parts with lower priority may be transcoded and/or delivered at a lower bitrate without perceived quality degradation or with minimized degradation.

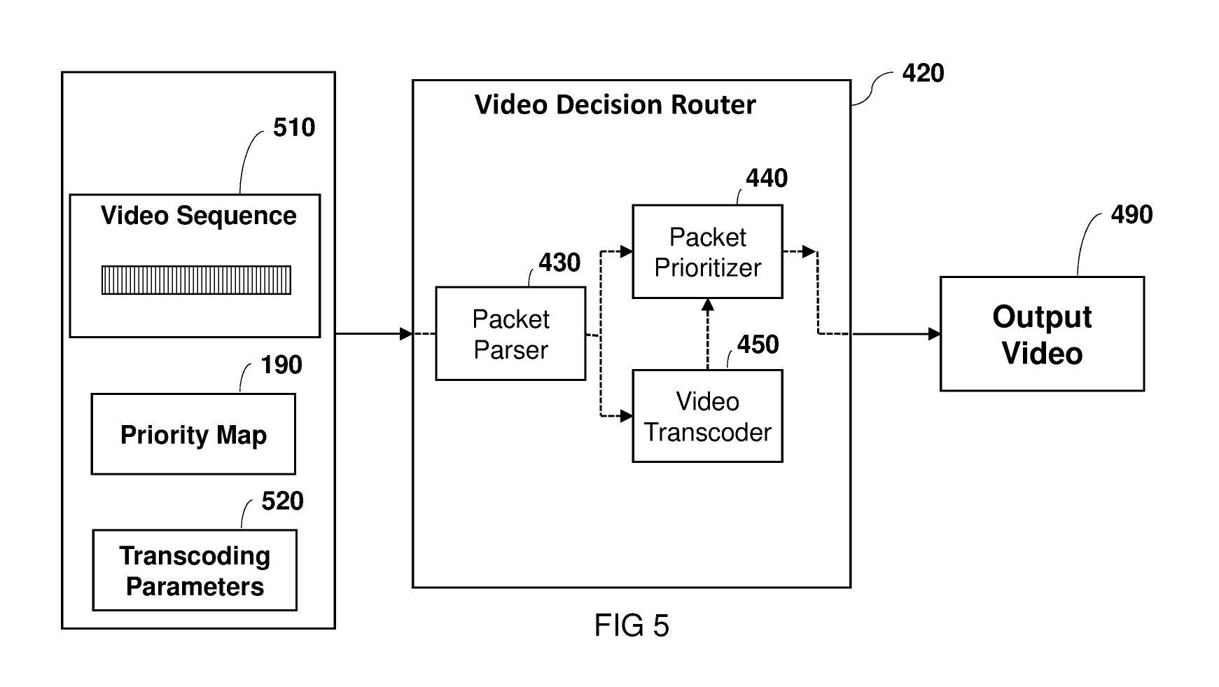

FIG. 5 is a depiction of a video decision router implemented in a smart channel node in accordance with an embodiment of the disclosed subject matter. As input to the VDR 420, a video sequence 510 can be same as video sequence 110, or a transcoded version of video sequence 110, and the associated PM 190 may also provide input to the VDR 420. VDR 420 may determine a transcoding technique or bitrate level for the video segment based on the determined priority map for each packet, or in the case of an adaptive streaming implementation, for each segment. A decision may be made by a packet parser (PP) 430, based on the priority coefficients that are contained in the sub-set of PM 190 for the particular packet or segment.

The decision can be to fetch the packet or segment at a different bitrate, or to perform efficient transcoding of the packet or segment. The video transcoder (VT) 450 may use transcoding parameters (TP) 520 that are provided by VPA 120. Using the PM 190, the packet parser 430 can map each incoming packet or segment to a particular video interval and the interval's associated set of coefficients. Based on the set of coefficients, the packet parser 430 may, for example, calculate a priority of the packet and compare it to a threshold priority value. If the priority of the packet is above a threshold value, the packet parser 430 may send it to the packet prioritizer 440 for sending at least a portion of the video packet without any degradation or transcoding. The packet parser 430 may further determine low priority portions of a video packet which can be efficiently transcoded at the video transcoder 450 and then sent to the packet prioritizer 440 for recombination. For example, for low priority portions, packets can be transcoded at a lower bitrate or transmitted at a lower bitrate representation.

The VDA 420 may also allow for smart prefetching of video packets or video segments prior to transmission in case excess bandwidth is available at any given time. This can guarantee that video packets or video segments with perceptual and/or cognitive priority are prefetched at suggested bitrate levels and prevents severe degradations that can happen due to variable bandwidth conditions. The same method can be used to fetch videos that are marked as important or having higher priority. The resulting output video 490 may have an improved or optimized bitrate that does not degrade perceived quality.

The disclosed subject matter may provide a means of determining a priority map either at the time of encoding a video sequence or for an already encoded video bitstream, by using compressed domain parameters. Furthermore, the disclosed subject matter may describe a way of implementing priority-based channel routing that allows network bandwidth optimization without the loss in perceived quality.

Although the disclosed subject matter has been described by way of examples of embodiments, it is to be understood that various other adaptations and modifications may be made within the spirit and scope of the disclosed subject matter.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture can provide functionality of the disclosed methods as a result of one or more processor executing software embodied in one or more tangible, computer-readable media. The software implementing various embodiments of the present disclosure can be stored in memory and executed by processor(s). A computer-readable medium can include one or more memory devices, according to particular needs. A processor can read the software from one or more other computer-readable media, such as mass storage device(s) or from one or more other sources via communication interface. The software can cause processor(s) to execute particular processes or particular parts of particular processes described herein, including defining data structures stored in memory and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

1. A method of video streaming, comprising:
generating, for a video sequence comprising a plurality of video intervals, a priority map identifying a set of coefficients for each video interval, wherein the set of coefficients correlate priority with at least one of spatial, temporal, and audio elements of each video interval;
determining, based on the priority map, at least one of a transcoding technique and a bitrate level for each segment of the video sequence; and
transmitting each segment according to the determined transcoding technique or bitrate level.

2. The method of claim 1, wherein the priority comprises cognitive and/or perceptual priority based on characteristics of a human visual system (HVS).

3. The method of claim 1, wherein the set of coefficients comprises coefficients relating to one or more of: audio analysis, screenplay analysis, metadata analysis, content analysis, and social signals analysis.

4. The method of claim 1, wherein each of the plurality of video intervals comprises an interval of variable duration aligned with a scene.

5. The method of claim 1, further comprising calculating boundaries of each of the plurality of video intervals based on one or more scene characteristics of the video sequence.

6. The method of claim 5, wherein the calculating boundaries comprises calculating such that a difference between coefficient sets of consecutive video intervals of the plurality of video intervals is maximized.

7. The method of claim 1, wherein each of the coefficients comprises a value between 0 and 1, and a higher value represents a higher priority.

8. The method of claim 7, wherein for a segment determined as having low cognitive or perceptual priority, the transmitting comprises transmitting the segment as transcoded to a lower bitrate or transmitting a lower bitrate representation of the segment.

9. The method of claim 1, further comprising identifying one or more of the segments having high cognitive or perceptual priority based on the priority map and pre-fetching the identified segments prior to transmission.

10. A method of video encoding, comprising:
generating, for a video sequence comprising a plurality of video intervals, a priority map identifying a set of coefficients for each video interval, wherein the set of coefficients correlate cognitive or perceptual priority with at least one of spatial, temporal, or audio elements of each video interval;
determining, based on the priority map, one of a transcoding technique or bitrate level for each segment of the video sequence; and
encoding each segment according to the determined transcoding technique or bitrate level.

11. The method of claim 10, wherein each of the plurality of video intervals comprises an interval is having variable duration aligned with a scene.

12. The method of claim 10, further comprising calculating boundaries of each of the plurality of video intervals based on one or more scene characteristics of the video sequence.

13. The method of claim 10, wherein the calculating boundaries comprises calculating such that a difference between coefficient sets of consecutive video intervals is maximized.

14. A system for video streaming, comprising:
a video receiver configured to receive a video sequence;
a video priority analyzer configured to:
determine a set of coefficients that correlate cognitive or perceptual priority with at least one of spatial, temporal, or audio elements of the video sequence; and
determine a priority map using the coefficients, wherein the set of coefficients is associated with a video interval of the video sequence; and
a video decision router configured to:
for each packet of the video sequence, select a transcoding technique or bitrate level for the video segment based on the determined priority map; and
transmit the packet according to the selected transcoding technique or bitrate level.

15. The system of claim 14, wherein the coefficients are based on one or more of audio analysis, screenplay analysis, metadata analysis, content analysis, and social signals analysis.

16. The system of claim 14, wherein the video priority analyzer is further configured to calculate boundaries of each video interval based on scene characteristics of the video sequence.

17. The system of claim 16, wherein the boundaries of each video interval are further calculated such that a difference between coefficient sets of consecutive video intervals is maximized.

18. The system of claim 14, wherein each of the coefficients comprises a value between 0 and 1 and a higher value represents a higher priority.

19. The system of claim 14, wherein the video decision router is further configured to identify packets having high cognitive or perceptual priority based on the priority map and pre-fetching the segments prior to transmission.

20. A non-transitory computer readable medium comprising instructions to perform the methods of one of claims 1-13.
